(19) United States
(12) Patent Application Publication
(10) Pub. No.: US 2017/0025042 A1
(43) Pub. Date: Jan. 26, 2017

(54) WEARABLE DEVICE CAPABLE OF INDICATING DIRECTION AND METHOD FOR RECOGNIZING DIRECTION AND CONTROL METHOD THEREOF

(71) Applicant: National Taiwan Normal University, Taipei City (TW)

(72) Inventors: Mei-Yung CHEN, Taipei City (TW); Jon-Chao HONG, Taipei City (TW); Jung-Cheng CHEN, Yilan County (TW); Jen-Chih LIU, Yilan County (TW); Hao-Ping HUANG, Yilan County (TW); Wei-Zhi LIN, Yilan County (TW)

(21) Appl. No.: 15/215,453

(22) Filed: Jul. 20, 2016

(30) Foreign Application Priority Data
Jul. 22, 2015 (TW) 104123714

(51) Int. Cl. G09B 21/00

(52) U.S. Cl. CPC G09B 21/009

(57) ABSTRACT

A wearable device capable of indicating direction is provided, including a wearable module, a plurality of acoustic wave sensors, a plurality of vibrators, and a control module. The wearable module is adapted to be worn on the user's body, the acoustic wave sensors and the vibrators are disposed on the wearable module in different directions. The control module is electrically connected to the acoustic wave sensors and the vibrators. Each acoustic wave sensor is driven by a sound signal generated by an external object to generate a response signal, the control module receives and compares the response signals to recognize the direction of the external object, and controls the vibrator to generate the vibration signal.

### BACKGROUND

1. Technical Field

The present disclosure relates to a wearable device capable of indicating direction, in particular, to a wearable device capable of indicating direction adapted to be worn on a portion of the body of a hearing-impaired user, and a method for recognizing direction and a control method thereof.

2. Description of Related Art

Generally, pedestrians not only pay attention to their surroundings to identify the potential threats while walking on the street using their eyes, but also by their hearing. However, if the pedestrian does not rely on hearing, it is difficult to perceive external objects which come from the pedestrian's back.

As far as the hearing impaired persons are concerned, they have difficulty in perceiving by hearing the vehicles or external objects which come from the back. For example, when a vehicle approaches and the driver honks a horn behind a hearing impaired person, the hearing impaired person is incapable of immediately recognizing the direction of the vehicle and the horn. In addition, when someone is calling behind a hearing impaired person, they are not able to sense it.

Although hearing aids facilitate the hearing-impaired person to hear sounds, they cannot provide the user with the function of promptly recognizing the direction of the sound. That is, the hearing-impaired user is unable to recognize the direction of the sound despite the hearing aid.

In view of the mentioned shortcomings, the present disclosure provides a wearable device capable of indicating direction to enable the hearing impaired person to recognize the direction of the sound.

### SUMMARY

An exemplary embodiment of the present disclosure provides a wearable device capable of indicating direction and a method for recognizing direction and a control method thereof.

According to one exemplary embodiment of the present disclosure, a wearable device capable of indicating direction is provided, which includes a wearable module, a plurality of acoustic wave sensors, a plurality of vibrators and a control module. The wearable module is adapted to be worn on a portion of the body of a user. The plurality of acoustic wave sensors and the plurality of vibrators are disposed on the wearable module in different directions, and the control module is disposed on the wearable module and electrically connected to the plurality of acoustic wave sensors and the plurality of vibrators. Each acoustic wave sensor senses a sound signal generated by an external object, and then is driven by the sound signal to generate a response signal. The signal strength of the response signal generated by each acoustic wave sensor varies with the sound intensity of the sound signal. The response signal generated by each acoustic wave sensor is transmitted to the control module. The control module compares the signal strength of the response signal generated by each acoustic wave sensor to recognize a direction from which the external object is approaching, and then controls the vibrator which corresponds to the direction which the external object is approaching from to generate a vibration signal.

The present disclosure further discloses a method for recognizing direction and a control method which are adapted to the wearable device capable of indicating direction, comprising the following steps: a plurality of acoustic wave sensors disposed on a wearable module in different directions sensing a sound signal generated by an external object; each acoustic wave sensor driven by the sound signal to generate a response signal and then transmitting the response signal to a control module; the control module receiving the response signal generated by each acoustic wave sensor and comparing the signal strength of the response signal generated by each acoustic wave sensor to recognize a direction from which the external object is approaching, wherein the control module is electrically connected with the plurality of vibrators; and when the direction from which the external object is approaching has been determined by the control module, the control module controlling one or more vibrators which correspond to the direction from which the external object is approaching to generate a vibration signal.

To sum up, the present disclosure is capable of recognizing the direction of sound or object, and generating a vibration to alert the user by the vibrator to potential threats. Thus the user, in particular the hearing impaired person, can recognize the direction of the sound or object to ensure the personal safety.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a three-dimensional diagram of the first embodiment of a wearable device capable of indicating direction according to the present disclosure.

FIG. 2 is a three-dimensional diagram illustrating the open mode of the first embodiment of a wearable device capable of indicating direction according to the present disclosure.

FIG. 3 is a schematic diagram of the system configuration of a wearable device capable of indicating direction according to the present disclosure.

FIG. 4 is a schematic diagram illustrating how a wearable device capable of indicating direction according to the present disclosure is operated to sense the direction from which an external object is approaching and to generate the vibration signal.

FIG. 5 is a schematic diagram illustrating the first embodiment of a wearable device capable of indicating direction according to the present disclosure which is worn on the user's neck.

FIG. 6 is a schematic diagram illustrating the first embodiment of a wearable device capable of indicating direction according to the present disclosure which is worn in front of the user's chest.

FIG. 7 is a schematic diagram illustrating the first embodiment of a wearable device capable of indicating direction according to the present disclosure which is worn on the user's elbow

FIG. 8 is a top view of the second embodiment of a wearable device capable of indicating direction according to the present disclosure.

FIG. 9 is a three-dimensional diagram of the second embodiment of a wearable device capable of indicating direction according to the present disclosure which is disposed on a hat.

FIG. 10 is a three-dimensional diagram of the third embodiment of a wearable device capable of indicating direction according to the present disclosure which is disposed on a hat.

FIG. 11 is a flowchart illustrating the control procedures of the control module of a wearable device capable of indicating direction according to the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

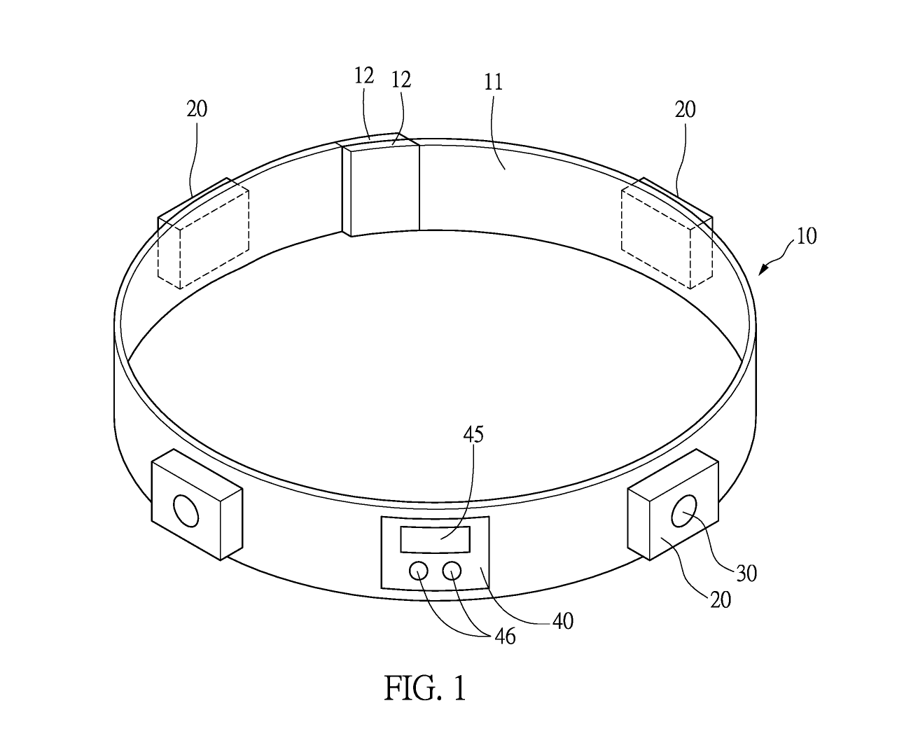

Please refer to FIG. 1 to FIG. 4 together. A wearable device capable of indicating direction of the present disclosure includes a wearable module 10, a plurality of acoustic wave sensors 30, a plurality of vibrators 20, and a control module 40. The wearable module 10 is adapted to be worn on a portion of the body of a user, so that the wearable device capable of indicating direction of the present disclosure can feasibly be worn by the user. The plurality of acoustic wave sensors 30 and the plurality of vibrators 20 are disposed on the wearable module 10 in different directions, and the control module 40 is disposed on the wearable module 10 and electrically connected to the plurality of acoustic wave sensors 30 and the plurality of vibrators 20.

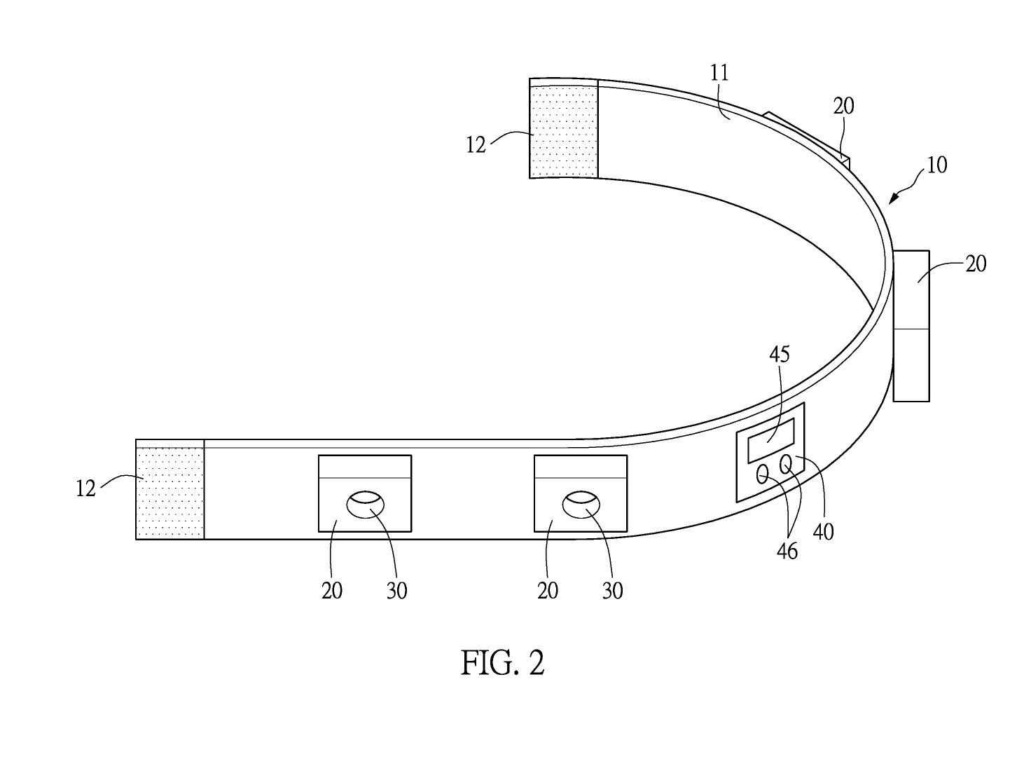

As shown in FIG. 1 and FIG. 2, the wearable module 10 includes a flexible strap 11, and the flexible strap 11 is made of fabric, rubber or soft material. In addition, two ends of the flexible strap 11 are respectively disposed with a connecting member 12, and the connecting member 12 may be Velcro or a fastener. The wearable module 10 can be formed as a circular shape (shown in FIG. 1) by connecting the two connecting members 12 respectively disposed at the two ends of the flexible strap 11. Alternatively, as shown in FIG. 2, the connecting members 12 respectively disposed at the two ends of the flexible strap 11 can be separated, allowing the wearable module 10 to be worn on any portion of the body of the user easily.

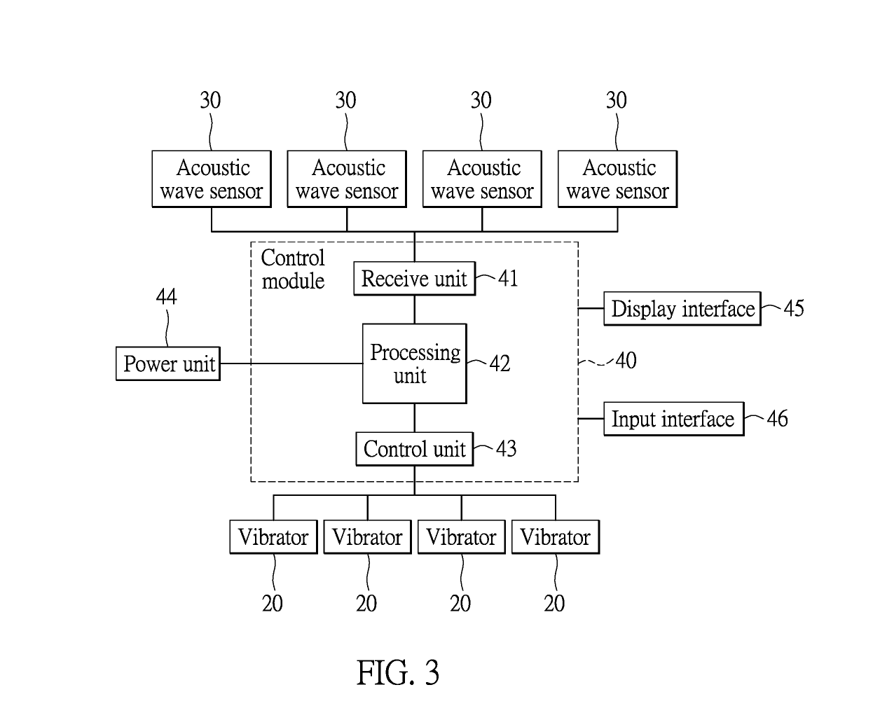

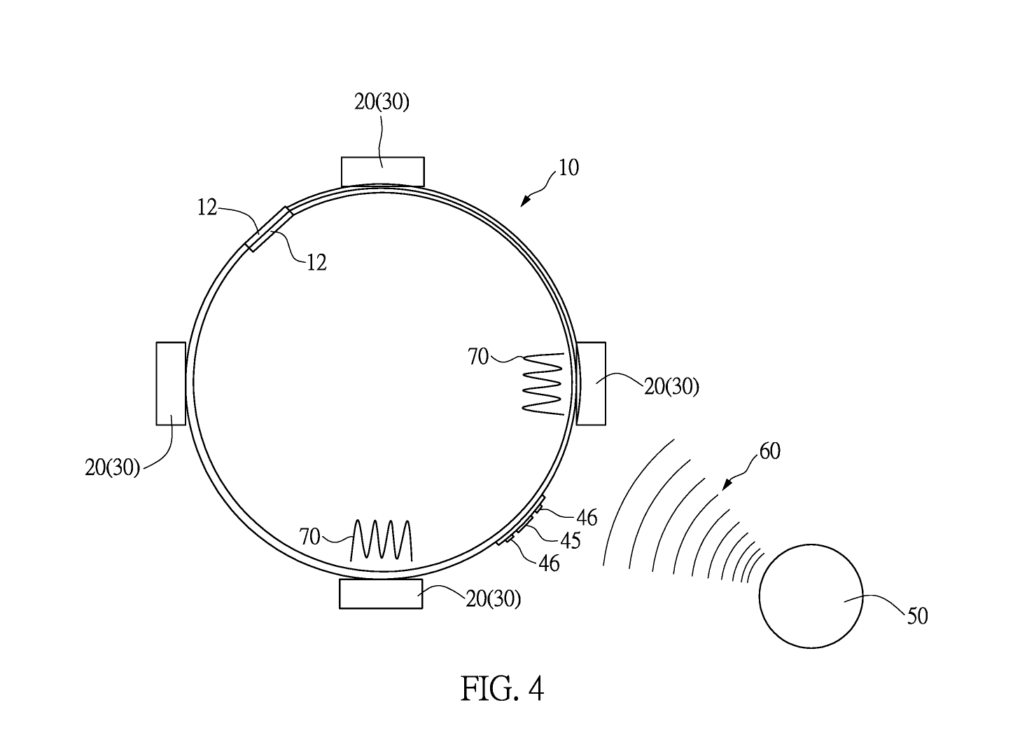

Please refer to FIG. 1, FIG. 3 and FIG. 4 together. Each of the acoustic wave sensors 30 and each of the vibrators 20 are connected with each other and respectively disposed on the wearable module 10 in different directions. In the present embodiment, four pairs of acoustic wave sensors 30 and vibrators 20 disposed on the wearable module 10 are used to sense a sound signal 60 generated by an external object 50. When receiving the sound signal 60, each acoustic wave sensor 30 is driven by the sound signal 60 to generate a response signal, and then transmits the response signal to the control module 40. When receiving the response signal generated by each acoustic wave sensor 30, the control module 40 compares the signal strength of the response signal generated by each acoustic wave sensor 30 to recognize a direction from which the external object 50 is approaching, and then controls each vibrator 20 to generate a vibration signal 70 to indicate the direction from which the external objects 50 is approaching the user.

Please refer to FIG. 3, which is a schematic diagram illustrating the system configuration of a wearable device capable of indicating direction according to the present disclosure. The control module 40 is electrically connected to the plurality of acoustic wave sensors 30 and the plurality of vibrators 20. The control module 40 includes a receive unit 41 used to receive the response signal generated by each acoustic wave sensor 30, a processing unit 42 used to compare the signal strength of the response signal generated by each acoustic wave sensor 30 to recognize the direction from which the external object 50 is approaching, a control unit 43 used to control each vibrator 20 to generate a vibration signal which corresponds to the direction from which the external object 50 is approaching, and a power unit 44 used to supply the plurality of acoustic wave sensors 30, the plurality of vibrators 20 and the control module 40 with the necessary power.

As shown in FIG. 1 and FIG. 4, the control module 40 further includes at least one display interface 45 and at least one input interface 46. Here, the display interface 45, which may be display devices such as an LCD display screen, LED display, LED indicator, and so on, is mainly used to display the signal strength of the response signal generated by each acoustic wave sensor 30. In addition, the display interface 45 is also used to display the reference information about the direction from which the external object 50 is approaching, the residual power of the control module 40, the operation parameters, and so on. The input interface 46, which provides the user with the function of inputting and adjusting the operation parameters, is mainly used to adjust a signal strength value. Here, the control module 40 determines whether or not to control the vibrator 20 to vibrate according to the signal strength value. That is, the control module 40 determines whether or not to control the vibrator 20 to generate the vibration signal based on the signal strength value. When the signal strength of the response signal is lower than the signal strength value, the control module 40 does not control the vibrator 20 to vibrate, and when the signal strength of the response signal is higher than the signal strength value, the control module 40 controls the vibrator 20 to the generate the vibration signal.

By adjusting the signal strength value through the input interface 46, the user can perceive the surroundings easily. For example, when in a noisy environment, the user increases the signal strength value through the input interface 46 to enable the control module 40 to control the vibrator 20 to vibrate only when the signal strength of the response signal generated by the acoustic wave sensor 30 is higher than the signal strength value. Thus it can prevent the vibrator 20 from generating unnecessary vibration when the acoustic wave sensor 30 receives a louder sound signal, thereby facilitating the sensitivity of the vibrator 20.

Please refer to FIG. 3 and FIG. 4 together. As shown in FIG. 3, the plurality of acoustic wave sensors 30 are electrically connected with the control module 40. As shown in FIG. 4, when the sound signal 60 generated by the external object 50 is transmitted to the wearable device capable of indicating direction of the present disclosure and each acoustic wave sensor 30 receives the sound signal 60, each acoustic wave sensor 30 is driven by the sound signal 60 to generate the response signal, and the response signal generated by each acoustic wave sensor 30 is then transmitted to the control module 40.

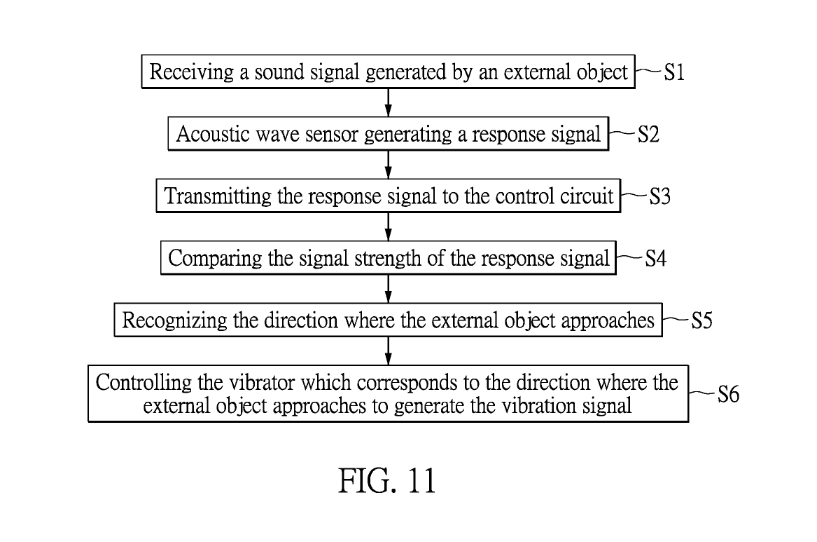

Please refer to FIG. 11, which is a flowchart illustrating the control procedures of the control module of the wearable device capable of indicating direction according to the present disclosure. The method includes the following steps: S1: when the external object 50 approaches, the acoustic wave sensor 30 receiving the sound signal 60 generated by the external object 50; S2: each acoustic sensor 30 driven by the sound signal 60 to generate the response signal. Here, as shown in FIG. 4, each acoustic wave sensor 30 is disposed on the wearable module 10 in different directions, and the distance and angle between each acoustic wave sensor 30 and the external object 50 are also different, so that each acoustic wave sensor 30 receives the sound signal 60 having different signal strength. In addition, the signal strength of the response signal generated by each acoustic wave sensor 30 varies with the sound intensity of the sound signal 60.

Please return to the flowchart shown in FIG. 11. S3: each acoustic wave sensor 30 transmitting the response signal to the control module 40 through the connection line; S4: after receiving the response signal transmitted by each acoustic wave sensor 30, the control module 40 comparing the signal strength of the response signal transmitted by each acoustic wave signal 30; S5: after the comparison, the control module 40 recognizing the direction of the sound signal generated by the external object 50; and S6: the control module 40 controlling each vibrator 20 to generate the vibration signal 70 to alert the user to the direction from which the external object 50 is approaching

The method of the control module 40 recognizing the direction from which the external object 50 is approaching and the vibrator 20 generating the vibration signal 70 in S4 to S6 is described as follows. As shown in FIG. 4, when the external object 50 approaches, the acoustic wave sensor 30 which faces or is close to the external object 50 receives the sound signal 60 having strong sound intensity, and the acoustic wave sensor 30 is driven by the sound signal 60 having strong sound intensity to generate a response signal having strong signal strength. By comparing the signal strength of the response signal generated by each acoustic wave sensor 30, the control module 40 is capable of recognizing the direction from which the external object 50 is approaching

Please refer to FIG. 4 and Table 1 (shown as below) together. The control module 40 of the present disclosure can compare the signal strength of the response signal generated by each acoustic wave sensor 30 to recognize the direction from which the external object 50 is approaching because when the direction from which the external object 50 is approaching faces one of the acoustic wave sensors 30, the acoustic wave sensor 30 which corresponds to the direction from which the external object 50 is approaching generates a response signal having strong signal strength. When the direction from which the external object 50 is approaching is between two acoustic wave sensors 30, the two acoustic wave sensors 30 which are close to the direction from which the external object 50 is approaching respectively generate a response signal having strong signal strength. Thus, when the control module 40 receives two response signals having the same signal strength and the signal strength of the two response signals is stronger than that of the response signals generated by the other acoustic wave sensors 30 which do not face or are not close to the direction from which the external object 50 is approaching, the control module 40 determines that the direction from which the external object 50 is approaching is between the two acoustic wave sensors 30 which respectively generate response signals having strong signal strength.

As shown in FIG. 4, the external object 50 approaches the wearable module 10 from the lower right corner, and the two acoustic wave sensors 30 respectively disposed at the right side and bottom of the wearable module 10 are closer to the external object 50 than the other acoustic wave sensors 30. The two acoustic wave sensors 30 which are closer to the external object 50 therefore sense sound signal having strong sound intensity, and are driven by the sound signal to generate a response signal having strong signal strength. Thus the control module 40 determines that the direction where the external object 50 approaches is between the two acoustic wave sensors 30 respectively disposed at the right side and bottom of the wearable module 10 according to the signal strength.

Similarly, when an external object 50 approaches the wearable device of the present disclosure from another direction, the control module 40 can determine the direction from which the external object 50 is approaching according to the above-mentioned method.

In the present embodiment, there are four acoustic wave sensors 30 respectively disposed on the wearable module 10 in different directions, such as front, rear, left and right. Table 1 shows the relationship between the signal strength of the response signal generated by each acoustic wave sensors 30 disposed on the wearable module 10 in different directions and the direction from which the external object 50 is approaching Thus the control module 40 can recognize the direction from which the external object 50 is approaching according the signal strength of the response signal generated by each acoustic wave sensor 30. As shown in table 1, when the external object 50 comes from the front, the acoustic wave sensor 30 disposed in front of the wearable module 10 generates a response signal having strong signal strength because the acoustic wave sensor 30 faces directly the external object 50, and at this point of time, the acoustic wave sensors 30 respectively disposed at left and right of the wearable module 10 both generate response signals having normal signal strength and the acoustic wave sensor 30 disposed at the rear of the wearable module 10 generates a weak signal strength. Thus the control module 40 determines that the external object 50 is coming from the front. When the external object 50 comes from the right front, the acoustic wave sensors 30 respectively disposed in front and at the right of the wearable module 10 both generate the response signal having strong signal strength while the acoustic wave sensors 30 respectively disposed at the left and rear of the wearable module 10 both generate response signals having weak signal strength. Thus the control module 40 determines that the external object 50 comes from the right front according to the signal strength. The method of the control module 40 determining the other directions from which the external object 50 is approaching is similar to that mentioned above, and unnecessary details are not given herein.

The relationship between the signal strength of the response signal generated by each acoustic wave sensor 30 and the direction from which the external object 50 is approaching is listed in Table 1 which can be used by the control module 40 as the determination logic for recognizing the direction from which the external object 50 is approaching

TABLE 1

| | Direction where the external object approaches | | | | | | | |
|---|---|---|---|---|---|---|---|---|
| Positions | | Right | | Right | | Left | | Left |
| of sensor | Front | front | Right | rear | Rear | rear | Left | front |
| Front | Strong | Strong | Normal | Weak | Weak | Weak | Normal | Strong |
| Rear | Weak | Weak | Normal | Strong | Strong | Strong | Normal | Weak |
| Left | Normal | Weak | Weak | Weak | Normal | Strong | Strong | Strong |
| Right | Normal | Strong | Strong | Strong | Normal | Weak | Weak | Weak |

It is noteworthy to mention that in the first embodiment of the present disclosure, the four acoustic wave sensors 30 respectively disposed in the directions of front, rear, left and right of the wearable module 10 are used to sense the eight directions including front, right front, right, right rear, rear, left rear, left and left front. In practice, an amount of the acoustic wave sensors 30 disposed on the wearable module 10 can be increased to recognize the direction from which the external object 50 is approaching more precisely.

As shown in FIG. 4, when the direction from which the external object 50 is approaching has been determined by the control module 40, the control module 40 controls one or more vibrators 20 which correspond to the direction from which the external object 50 is approaching to generate the vibration signal, thereby alerting the user. Here, the method of the control module 40 controlling the vibrator 20 to generate the vibration signal to indicate the direction from which the external object 50 is approaching is the same as the method of the control module 40 recognizing the direction from which the external object 50 is approaching according to the response signal generated by the acoustic wave sensor 30, which uses one or more vibrators 20 disposed on the wearable module 40 in different directions to vibrate to indicate the direction from which the external object 50 is approaching

In the present embodiment, each vibrator 20 is disposed corresponding to each acoustic wave sensor 30. When the direction from which the external object 50 is approaching has been determined by the control module 40, the control module 40 controls one or more vibrators 20 which correspond to one or more acoustic wave sensors 30 that generates the response signal having strong signal strength to generate the vibration signal, so that the vibration signal generated by the one or more vibrators 20 corresponds to the direction from which the external object 50 is approaching

As shown in FIG. 4, the method of each vibrator 20 generating the vibration signal is the same as the method of the control module 40 recognizing the direction from which the external object 50 is approaching. As shown in FIG. 2 and FIG. 4, the vibrators 20 are respectively disposed on the wearable module 10 in the directions of front, rear, left and right. When the external object 50 approaches the wearable module 10 from one of the four directions, the control module 40 controls the vibrator 20 which corresponds to the direction from which the external object 50 is approaching to generate the vibration signal. When the external object 50 comes from the directions of right front, right rear, left rear, or left front, the control module 40 controls the two vibrators 20 which are close to the direction from which the external object 50 is approaching to generate the vibration signal, thereby alerting the user to the direction from which the external object 50 is approaching

The wearable module 10 of the wearable device capable of indicating direction of the first embodiment includes the flexible strap 11 adapted to be worn on a portion of the body of the user. The flexible strap 11 shown in FIG. 1 can be feasibly worn on the user's head because the user's head and the flexible strap 11 have a similar diameter.

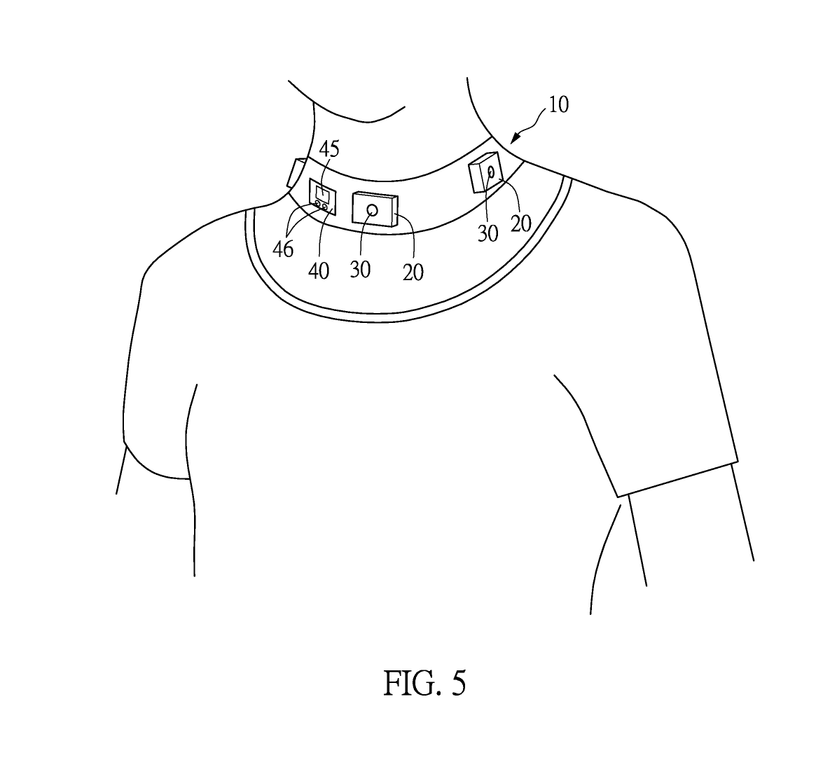

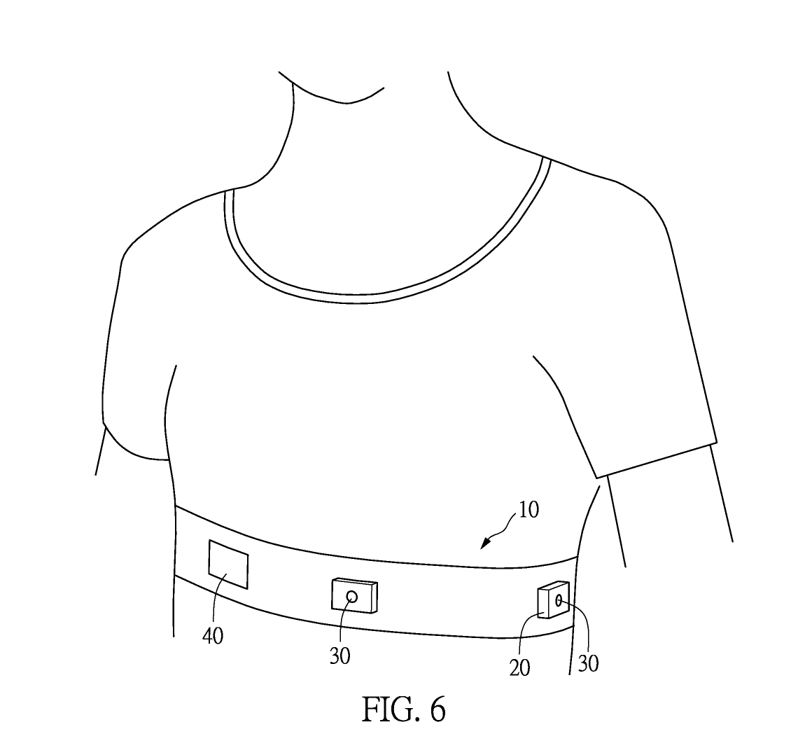

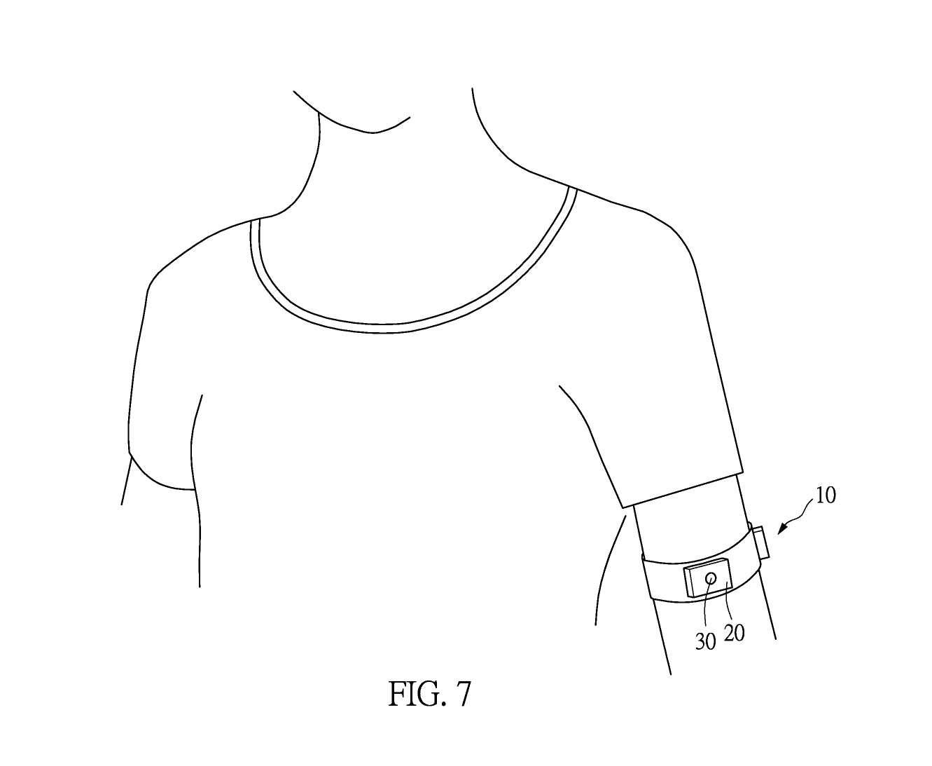

In addition to being worn on the user's head, the flexible strap 11 can feasibly be worn on the user's neck as shown in FIG. 5, or in front of the chest as shown in FIG. 6. Alternatively, the flexible strap 11 can be minimized to be a bracelet which is adapted to be worn on the user's elbow as shown in FIG. 7.

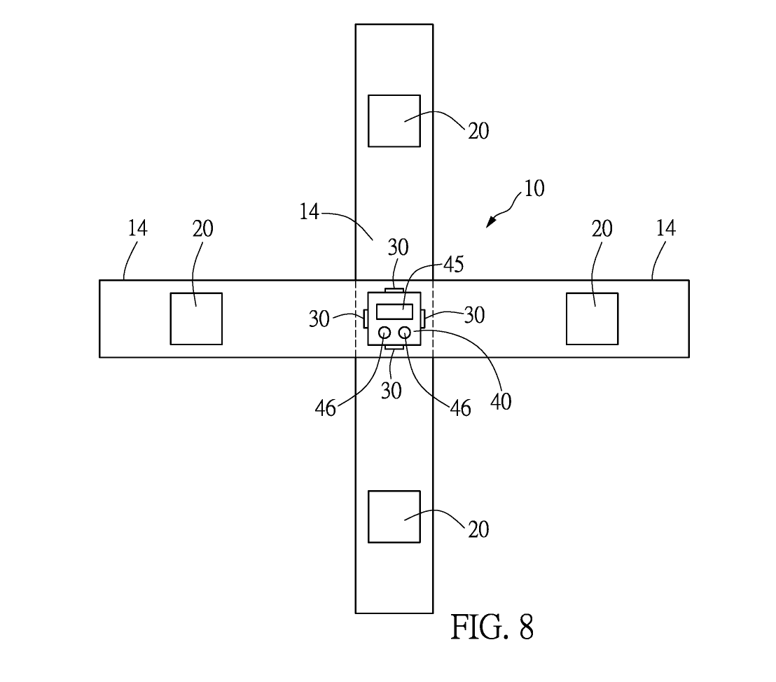

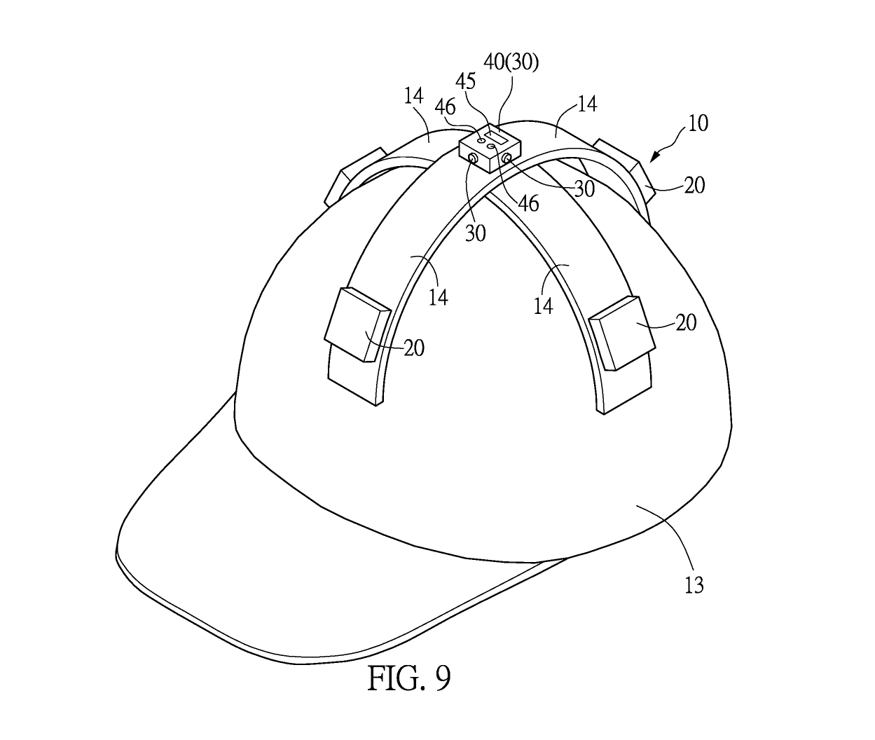

Please refer to FIG. 8 and FIG. 9, which show the second embodiment of the present disclosure. The wearable module 10 shown in FIG. 8 and FIG. 9 includes two fastening bands 14 which are made of soft or plastic material. The two fastening bands 14 are strip-shaped and crossed, and have the same length. Four vibrators 20 are respectively disposed at the ends of the two fastening bands 14. The control module 40 and the plurality of acoustic wave sensors 30 are integrated to be an assembly and disposed in the central portion of the two fastening bands 14.

As shown in FIG. 9, the wearable module 10 of the wearable device capable of indicating direction of the present disclosure further includes a hat 13. The two fastening bands 14 on which the plurality of vibrators 20, the plurality of acoustic wave sensors 30 and the control module 40 are disposed can be stuck or sewed on the hat 13, so that the wearable device capable of indicating direction of the present embodiment can be worn on the user's head.

In the second embodiment, the plurality of acoustic wave sensors 30 and the control module 40 are integrally disposed to be an assembly, and there are four acoustic wave sensors 30 disposed on the wearable module 10 in different directions. In the present embodiment, the operations of the control module 40, the acoustic wave sensor 30 and the vibrator 20 are the same as that mentioned in the first embodiment. Thus unnecessary details are not given herein.

The second embodiment discloses another aspect of the wearable device capable of indicating direction of the present disclosure and another configuration of the acoustic wave sensor 30 and the vibrator 20. In the present embodiment, the two fastening bands 14 of the wearable module 10 are detachably disposed on the hat 13, and the wearable device capable of indicating direction of the present embodiment is adapted to be disposed on different types of hat, thereby promoting the utility thereof

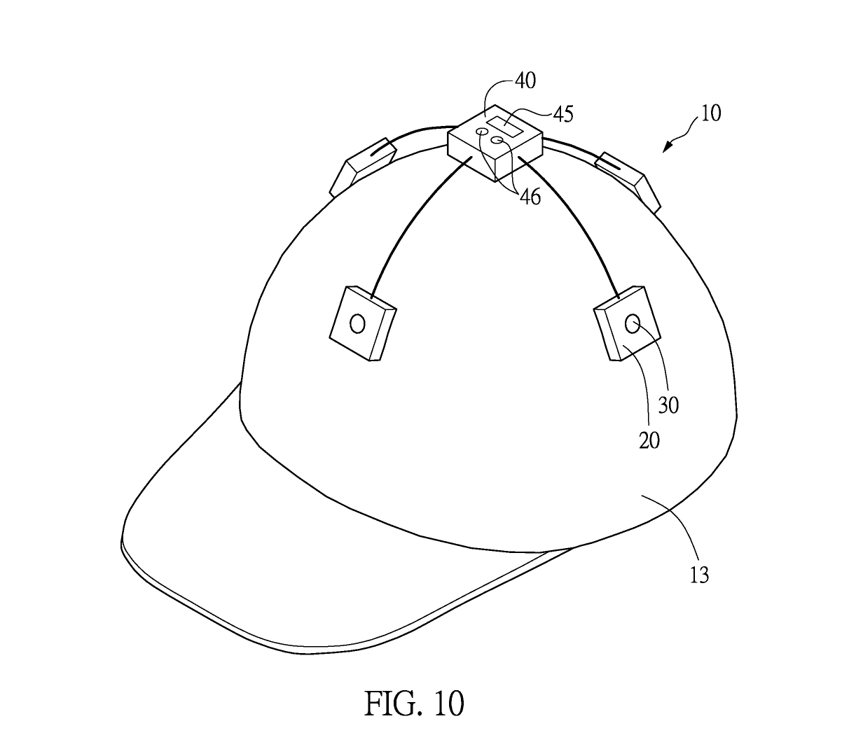

Please refer to FIG. 10, which is the third embodiment of the present disclosure. The wearable module 10 of the present embodiment includes the hat 13 on which the plurality of vibrators 20 are disposed in different directions. In addition, the plurality of acoustic wave sensors 30 and the plurality of vibrators 20 are integrally disposed on the hat in different directions.

In the present embodiment, the control module 40 is disposed in the central portion of the hat 13, and electrically connected with the plurality of acoustic wave sensors 30 and the plurality of vibrators 20 by wires. The control module 40 can control the plurality of acoustic wave sensors 30 and the plurality of vibrators 20 according to the above-mentioned method because the operations of each component described in each embodiment are the same.

It is noteworthy that the wires used to connect the plurality of acoustic wave sensors 30 and the plurality of vibrators 20 with the control module 40 are disposed outside the hat 13, but it is not limited thereto. In practice, the wires, the plurality of acoustic wave sensors 30, the plurality of vibrators 20 and the control module 40 all can be disposed inside the hat 13, thereby maintaining the appearance of the hat 13.

In summary, the wearable device capable of indicating direction of the present disclosure can identify the direction of the sound signal generated by an external object to recognize the direction from which the external object is approaching, and then alert the user to the direction from which the external object is approaching by means of vibration. Thus the wearable device capable of indicating direction of the present disclosure enables the hearing-impaired user to recognize the direction from which the external object is approaching to perceive potential damage from the surroundings, thereby ensuring personal safety.

The wearable device capable of indicating direction of the present disclosure can be formed as a hat, a bracelet, a neck ring, a chest band, and so on. In addition, it can integrate with clothes, accessories . . . etc. so as to be worn on the user easily, thereby promoting the usability thereof

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A wearable device capable of indicating direction, comprising:
a wearable module adapted to be worn on a portion of the body of a user;
a plurality of acoustic wave sensors disposed on the wearable module in different directions;
a plurality of vibrators disposed on the wearable module in different directions; and
a control module disposed on the wearable module and electrically connected with the plurality of acoustic wave sensors and the plurality of vibrators;
wherein each acoustic wave sensor senses a sound signal generated by an external object and then is driven by the sound signal to generate a response signal, and the signal strength of the response signal generated by each acoustic wave sensor varies with the sound intensity of the sound signal; and
the response signal generated by each acoustic wave sensor is transmitted to the control module, and the control module compares the signal strength of the response signal generated by each acoustic wave sensor to recognize a direction from which the external object is approaching, and then controls the vibrator which corresponds to the direction from which the external is approaching to generate a vibration signal.

2. The wearable device capable of indicating direction according to claim 1, wherein the control module controls one or more vibrators which correspond to the direction from which the external object is approaching to generate the vibration signal when the direction from which the external object is approaching has been determined by the control module.

3. The wearable device capable of indicating direction according to claim 1, wherein the wearable module comprises a flexible strap on which the plurality of acoustic wave sensors and the plurality of vibrators are respectively disposed.

4. The wearable device capable of indicating direction according to claim 1, wherein the wearable module comprises a hat on which the plurality of acoustic wave sensors and the plurality of vibrators are respectively disposed.

5. The wearable device capable of indicating direction according to claim 1, wherein the wearable module further comprises a plurality of fastening bands on which the plurality of acoustic wave sensors and the plurality of vibrators are respectively disposed, and the plurality of fastening bands are detachably disposed on the hat.

6. The wearable device capable of indicating direction according to claim 1, wherein the control module further comprises at least one display interface and at least one input interface, wherein the display interface displays the signal strength of the response signal generated by each acoustic wave sensor and the input interface provides the user with a function of inputting and adjusting a signal strength value, and the control module determines whether or not to activate the vibrator to vibrate according to the signal strength value.

7. A method for recognizing direction and a control method adapted to a wearable device capable of indicating direction, comprising the following steps:
a plurality of acoustic wave sensors disposed on a wearable module in different directions sensing a sound signal generated by an external object, and each acoustic wave sensor driven by the sound signal to generate a response signal and then transmitting the response signal to a control module;
when receiving the response signal generated by each acoustic wave sensor, the control module comparing the signal strength of the response signal generated by each acoustic wave sensor to recognize the direction from which the external object is approaching according to the signal strength; and
the control module controlling one or more vibrators which correspond to the direction from which the external object is approaching to generate a vibration signal when the direction from which the external object is approaching has been determined by the control module.

8. The method according to claim 7, wherein when one of the acoustic waves generates the response signal having a strong signal strength, the control module determines that the direction of the acoustic wave sensor which generates the response signal having the strong signal strength corresponds to the direction from which the external object is approaching; and when two of the acoustic wave sensors respectively generate the response signal having the strong signal strength, the control module determines that the direction between the two acoustic wave sensors which generate the response signal having the strong signal strength corresponds to the direction from which the external object is approaching

9. The method according to claim 7, wherein each vibrator and each acoustic wave sensor are disposed correspondingly; when the direction from which the external object is approaching has been determined by the control module, the control module controls one or more vibrators which correspond to one or more acoustic wave sensors that generate the response signal having the strong signal strength to generate the vibration signal.

10. The method according to claim 7, further comprising an input interface, wherein the input interface provides the user with a function of inputting and adjusting a signal strength value, and the control module determines whether or not to activate the vibrator to vibrate according to the signal strength value; when the signal strength of the response signal is lower than the signal strength value, the control module does not control the vibrator to vibrate, and when the signal strength of the response signal is higher than the signal strength value, the control module controls the vibrator to the generate the vibration signal.
